(19) United States
(12) Patent Application Publication
(10) Pub. No.: US 2014/0338607 A1
(43) Pub. Date: Nov. 20, 2014

(54) ABSORBENT SHEET FOR PETS

(71) Applicant: Uni-Charm Corporation, Ehime (JP)

(72) Inventors: Chiyo Takagi, Kagawa (JP); Takeshi Ikegami, Kagawa (JP)

(21) Appl. No.: 14/278,301

(22) Filed: May 15, 2014

(30) Foreign Application Priority Data
May 17, 2013 (JP) 2013-105643

(51) Int. Cl. A01K 1/015

(52) U.S. Cl. CPC A01K 1/0157
USPC 119/161

(57) ABSTRACT

A placing surface of a pet absorbent sheet that has an adhesion region which can adhere to a placing object. The adhesion region has a first adhesion region and a second adhesion region formed in a different manner from the first adhesion region.

### TECHNICAL FIELD OF THE INVENTION

The present invention relates to an absorbent sheet for pets.

### BACKGROUND OF THE INVENTION

Conventionally, an absorbent sheet for pets is used particularly for disposing of excrement of pets which are kept indoors. Various structures of absorbent sheet for pets have been provided. An example of an absorbent sheet for pets is disclosed in Japanese laid-open Patent Publication No. 2003-325068.

This known absorbent sheet for pets is attached to a placing object such as floor by a double-faced adhesive tape. Structurally, however, this pet absorbent sheet cannot be attached to a placing object in different manners depending on the kind of the placing object (flooring).
Patent Document 1: Japanese non-examined laid-open Patent Publication No 2003-325068.

### SUMMARY OF THE INVENTION

Accordingly, it is an object of the present invention to provide an improved technique for rationally constructing an absorbent sheet for pets.

In order to solve the above-described problem, according to a preferred aspect of the present invention, a pet absorbent sheet includes a liquid-permeable first sheet, a liquid-impermeable second sheet, an absorbing core disposed between the first sheet and the second sheet, an excretion surface on which a pet excretes, and a placing surface opposite to the excretion surface. Further, the placing surface has an adhesion region which can adhere to a placing object. The adhesion region has a first adhesion region and a second adhesion region formed in a different manner from the first adhesion region.

Specifically, by provision of the first adhesion region and the second adhesion region in the placing surface, the pet absorbent sheet of this invention can ensure good adhesion to various kinds of placing objects. Furthermore, the pet absorbent sheet can be attached to a placing object with strength desired by a user

According to a further aspect of this invention, adhesive force in the first adhesion region is rendered weaker than adhesive force in the second adhesion region. Thus, the first adhesion region is formed in a different manner from the second adhesion region.

According to a further aspect of this invention, the adhesion region comprises an adhesive region having an adhesive applied thereto.

According to a further aspect of this invention, adhesives having the same composition are applied to the first and second adhesion regions, and an adhesive force reducing region for reducing adhesive force is formed in the first adhesion region. Thus, the adhesive force in the first adhesion region is rendered weaker than adhesive force in the second adhesion region

According to a further aspect of this invention, the adhesive force reducing region is formed in part of the first adhesion region by embossing.

According to a further aspect of this invention, the adhesive force reducing region is formed in part of the first adhesion region by applying powder thereto.

According to a further aspect of this invention, the adhesive force reducing region is formed in part of the first adhesion region by not providing the adhesive therein.

According to a further aspect of this invention, a release sheet is disposed on at least part of the adhesion region. The release sheet has a first release sheet surface on one side facing the adhesion region and a second release sheet surface on the other side. The adhesion region of the pet absorbent sheet is covered with the release sheet until use. Thus, the adhesion region can be prevented from adhering to an unintended place.

### Effect of the Invention

According to this invention, an improved technique for rationally constructing an absorbent sheet for pets can be provided.

### BRIEF DESCRIPTION OF THE DRAWINGS

FIG. 1 is a perspective view showing a basic structure of a pet absorbent sheet according to the present invention.

FIG. 2 is a front view showing the basic structure of the pet absorbent sheet according to the present invention.

FIG. 3 is a bottom view showing the basic structure of the pet absorbent sheet according to the present invention.

FIG. 4 is a perspective view of a release sheet.

FIG. 5 is a sectional view taken along line VII-VII in FIG. 4.

FIG. 6 is an explanatory drawing of a pet absorbent sheet according to a first embodiment pattern of the present invention.

FIG. 7 is an explanatory drawing of a pet absorbent sheet according to a second embodiment pattern of the present invention.

FIG. 8 is an explanatory drawing of a pet absorbent sheet according to a third embodiment pattern of the present invention.

FIG. 9 is an explanatory drawing of a pet absorbent sheet according to a fourth embodiment pattern of the present invention.

FIG. 10 is an explanatory drawing of the pet absorbent sheet according to the fourth embodiment pattern of the present invention.

FIG. 11 is an explanatory drawing of a pet absorbent sheet according to a fifth embodiment pattern of the present invention.

FIG. 12 is an explanatory drawing of the pet absorbent sheet according to the fifth embodiment pattern of the present invention.

FIG. 13 is an explanatory drawing of a pet absorbent sheet according to a sixth embodiment pattern of the present invention.

FIG. 14 is an explanatory drawing of a pet absorbent sheet according to a seventh embodiment pattern of the present invention.

FIG. 15 is an explanatory drawing of the pet absorbent sheet according to the seventh embodiment pattern of the present invention.

FIG. 16 is an explanatory drawing of the pet absorbent sheet according to the seventh embodiment pattern of the present invention.

FIG. 17 is an explanatory drawing of a pet absorbent sheet according to an eighth embodiment pattern of the present invention.

FIG. 18 is an explanatory drawing of a pet absorbent sheet according to a ninth embodiment pattern of the present invention.

FIG. 19 is an explanatory drawing of a pet absorbent sheet according to a tenth embodiment pattern of the present invention.

FIG. 20 is an explanatory drawing of a pet absorbent sheet according to an eleventh embodiment pattern of the present invention.

FIG. 21 is an explanatory drawing of a pet absorbent sheet according to a twelfth embodiment pattern of the present invention.

FIG. 22 is an explanatory drawing of the pet absorbent sheet according to the twelfth embodiment pattern of the present invention.

FIG. 23 is an explanatory drawing of a pet absorbent sheet according to a thirteenth embodiment pattern of the present invention.

FIG. 24 is an explanatory drawing of the pet absorbent sheet according to the thirteenth embodiment pattern of the present invention.

### DETAILED DESCRIPTION OF THE INVENTION

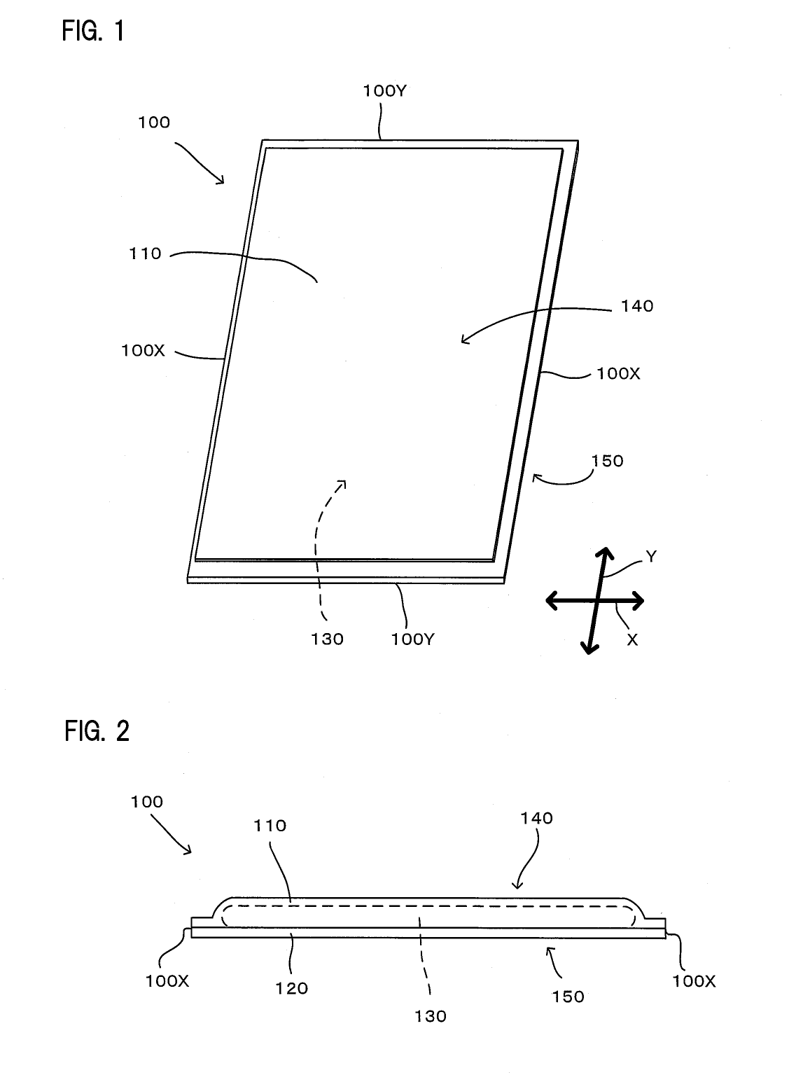

A pet absorbent sheet according to the present invention is described hereinbelow with reference to FIGS. 1 to 24. An “animal” here widely includes vertebrates (mammals, reptiles, birds and amphibians) and invertebrates, but typically represents pets such as cats, dogs, rabbits and hamsters.

### (Basic Structure)

The basic structure of a pet absorbent sheet according to this invention is now explained with reference to FIGS. 1 to 5.

A pet absorbent sheet 100 includes a liquid-permeable top sheet 110, a liquid-impermeable back sheet 120, and an absorbing core 130 disposed between the top sheet 110 and the back sheet 120. The pet absorbent sheet 100 here is a feature that corresponds to the pet absorbent sheet according to this invention. The top sheet 110, the back sheet 120 and the absorbing core 130 here are features that correspond to the “first sheet”, the “second sheet” and the “absorbing core”, respectively, according to this invention.

The pet absorbent sheet 100 is a flat sheet having a predetermined thickness. The pet absorbent sheet 100 is spread out flat with the back sheet 120 on an intended or desired place (placing object). This state is a pet use mode for receiving excrement of pets. The “excrement of pets” here widely includes not only urine, but body fluids such as saliva and menstrual blood.

In the pet use mode, the top sheet 110 forms an excretion surface 140 on which a pet excretes. The back sheet 120 has a placing surface 150 which is formed on the side opposite to the excretion surface 140 and placed on a placing object (intended place). The excretion surface 140 and the placing surface 150 are features that correspond to the “excretion surface” and the “placing surface”, respectively, according to this invention.

The manner in which the placing surface 150 is placed on the “placing object” includes a manner in which the pet absorbent sheet 100 is directly placed on floor or the like, and a manner in which the pet absorbent sheet 100 is set on a holder and placed on floor or the like.

The floor on which the pet absorbent sheet 100 is placed may be made of various materials with various structures. For example, synthetic resin such as vinyl and linoleum, wood coated with wax or oil, uncoated wood, vegetable fibers represented by tatami mat, or fibers with or without loops may be used.

The pet absorbent sheet 100 preferably has a rectangular or square shape, but it may have a circular, elliptical or polygonal shape.

The pet absorbent sheet 100 according to this invention is rectangular and extends in a longitudinal direction Y and a lateral direction X transverse to the longitudinal direction Y. The pet absorbent sheet 100 has a pair of longitudinal ends 100Y in the longitudinal direction Y and a pair of lateral ends 100X in the lateral direction X.

In the case of the pet absorbent sheet 100 having a complete round shape in which the longitudinal direction Y cannot be identified, one direction in the pet absorbent sheet 100 may be defined as the longitudinal direction Y and the other direction transverse to the longitudinal direction Y may be defined as the lateral direction X.

The top sheet 110, the back sheet 120 and the absorbing core 130 may each have a structure and arrangement appropriately selected from those of known pet absorbent sheets, and therefore, for the sake of expedience, their description is omitted.

The top sheet 110 may be formed of thermoplastic nonwoven fabric, including spun-bond nonwoven fabric of thermoplastic long fibers, air-through nonwoven fabric of thermoplastic short fibers, point-bond nonwoven fabric and perforated film.

The back sheet 120 may be preferably formed particularly by a resin film sheet in order to ensure its liquid-impermeability. For example, a film of polyethylene, polypropylene or polyethylene terephthalate may be used to form the back sheet 120. Further, in consideration of flexibility, the back sheet 120 may be formed by a nonwoven fabric to which a water repellent is applied.

The absorbing core 130 may be formed of a mixture of granular or fibrous high-absorbent polymers and fluff pulp, or a mixture of granular or fibrous high-absorbent polymers, fluff pulp and thermoplastic rigid resin fibers.

The placing surface 150 of the pet absorbent sheet 100 has an adhesion region 200 which can adhere to a placing object. The adhesion region 200 has a first adhesion region 210 and a second adhesion region 220. The first adhesion region 210 is formed in a different manner from the second adhesion region 220. The adhesion region 200, the first adhesion region 210 and the second adhesion region 220 are features that correspond to the “adhesion region”, the “first adhesion region” and the “second adhesion region”, respectively, according to this invention.

The adhesive force in the first adhesion region 210 is rendered weaker than that in the second adhesion region 220. Thus, the first adhesion region 210 is formed in a different manner from the second adhesion region 220.

The “adhesive force” in this invention includes not only a force to fix the adhesion region 200 to a placing object, but a force to separate the pet absorbent sheet 100 with the placing surface 150 attached to the placing object by the adhesion region 200, from the placing object. Specifically, the adhesive force includes a force to separate the attached pet absorbent sheet by vertically pulling it up off the placing object, and a force to separate the attached pet absorbent sheet by holding an end (the longitudinal end 100Y or the lateral end 100X) of the pet absorbent sheet and pulling it obliquely upward.

In order to determine whether the adhesive force is weak or strong, it is necessary to consider the relative relation between the adhesion region 200 and the placing object. When, for example, one of the adhesion regions 200 has an adhesive 230 and the other adhesion region 200 has numerous hooks 241 as described below, and the placing object is flat and smooth like vinyl flooring, the one adhesion region 200 is provided to have a stronger adhesive force. Therefore, in this case, the other adhesion region 200 having the hooks 241 forms the first adhesion region 210, and the one adhesion region 200 having the adhesive 230 forms the second adhesion region 220. On the other hand, when the placing object is flooring having fiber loops, the other adhesion region 200 is provided to have a stronger adhesive force. Therefore, in this case, the one adhesion region 200 having the adhesive 230 forms the first adhesion region 210, and the other adhesion region 200 having the hooks 241 forms the second adhesion region 220. The adhesive 230 and the hooks 241 are features that correspond to the “adhesive” and the “hooks”, respectively, according to this invention.

Further, for example, the one adhesion region 200 and the other adhesion region 200 may have the same adhesive force to one placing object. Even in such a case, if they have different adhesive forces to the other placing object, the first adhesion region 210 and the second adhesion region 220 are accordingly formed.

Further, for example, the one adhesion region 200 may have a stronger separation force in a vertical direction, but have a weaker separation force in an obliquely upward direction than the other adhesion region 200. In such a case, the first adhesion region 210 and the second adhesion region 220 are accordingly formed in each situation of separation.

For convenience of explanation, in this specification, the first and second adhesion regions 210, 220 may be explained and illustrated in the drawings without particularly considering the above-described relation with the materials and structure of the flooring.

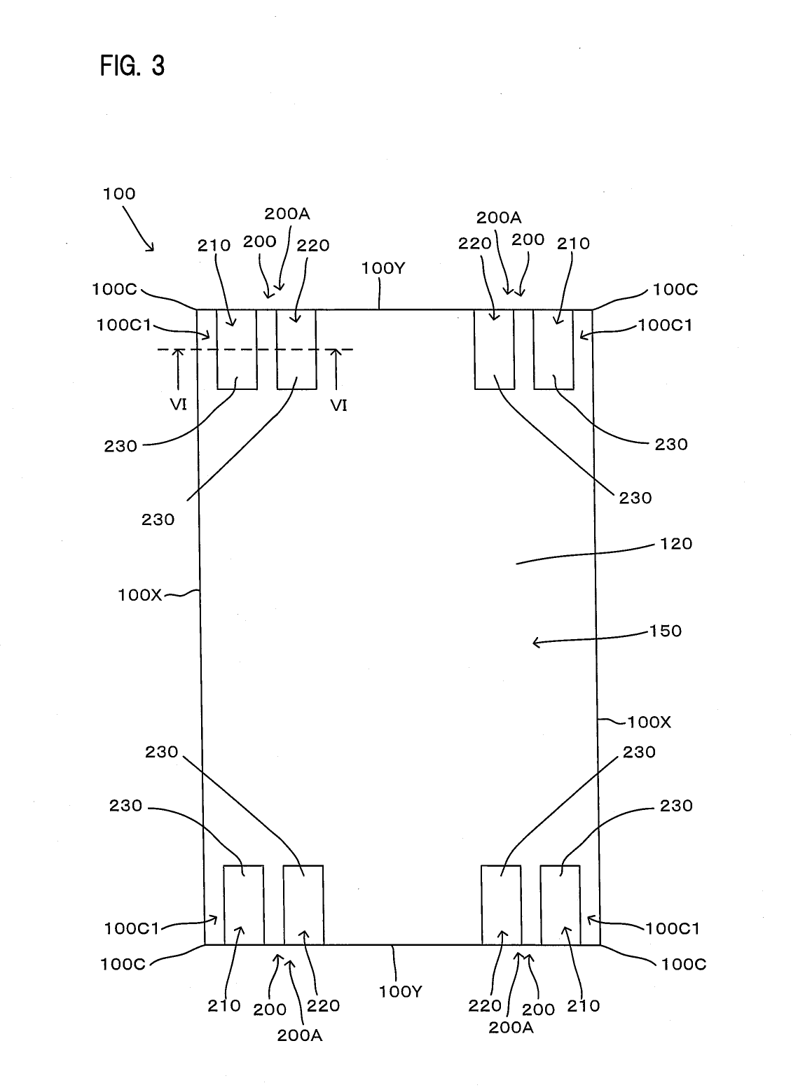

In the pet absorbent sheet 100 shown in FIG. 3, the first adhesion regions 210 and the second adhesion regions 220 have the adhesive 230.

The adhesive 230 may be a rubber, acrylic elastomer or acrylic resin adhesive. Or the adhesive 230 may be an ethylene-vinyl acetate copolymer (EVA) or polyolefin hot-melt adhesive. Further, the adhesive 230 may be an adhesive having a tackifier such as terpene resin. The adhesive 230 may be designed not only to fix the pet absorbent sheet 100 to the placing object by the adhesive force, but it may be only necessary to have an effect of increasing the resistance against the placing object. Urethane resin is preferably used as the adhesive 230 which increases the resistance against the placing object.

A pair of the first and second adhesion regions 210, 220 adjacent to each other forms an adjacent adhesion region 200A. A plurality of such adjacent adhesion regions 200A are arranged on the placing surface 150 of the pet absorbent sheet 100. In the pet absorbent sheet 100, corner regions 100C1 are formed in regions where the longitudinal ends 100Y and the lateral ends 100X intersect with each other and form corners 100C. The adjacent adhesion regions 200A are arranged in the corner regions 100C1. The pet absorbent sheet 100 shown in FIG. 3 has a rectangular shape having four corner regions 100C1. The adjacent adhesion regions 200A are provided in all of the four corner regions 100C1.

An end of each adhesion region 200 coincides with an end of the pet absorbent sheet 100. In FIG. 3, each of the first and second adhesion regions 210, 220 forming the adhesion region 200 has an end in the longitudinal direction Y which is provided to coincide with the longitudinal end 100Y of the pet absorbent sheet 100. When the placing surface 150 of the pet absorbent sheet 100 is fixed on a placing object by the adhesion region 200, the longitudinal end 100Y of the pet absorbent sheet 100 is closely attached in the adhesion region 200 to the placing object. Thus, the longitudinal end 100Y of the pet absorbent sheet 100 in the adhesion region 200 can be prevented from being turned up by a pet.

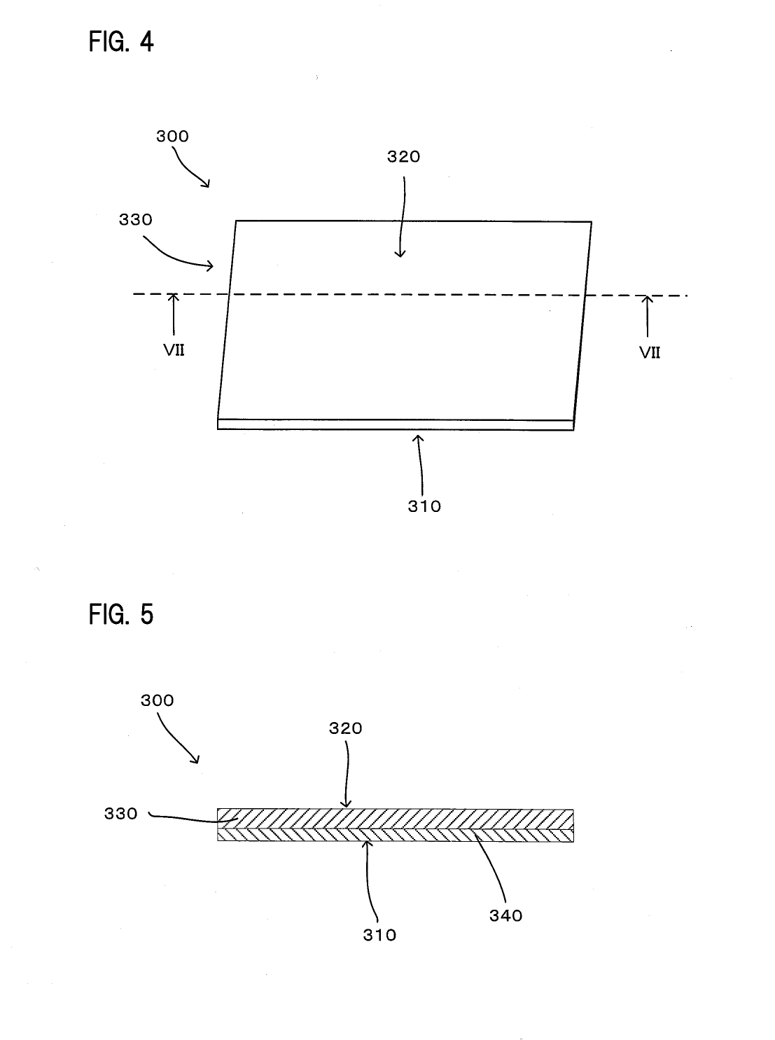

FIGS. 4 and 5 show a release sheet 300 which is provided on the adhesion region 200. The release sheet 300 includes a first release sheet surface 310 on one side facing the adhesion region 200, and a second release sheet surface 320 on the other side. The release sheet 300, the first release sheet surface 310 and the second release sheet surface 320 are features that correspond to the “release sheet”, the “first release sheet surface”, and the “second release sheet surface”, respectively, according to this invention.

The first release sheet surface 310 has an inhibiting region 340 for inhibiting adhesion to the adhesion region 200. It is only necessary for the inhibiting region 340 to be provided at least on part of the first release sheet surface 310 and not on its entirety. The inhibiting region 340 is provided on a release sheet body 330.

The release sheet body 330 is made of semi-bleached paper, high-quality paper, glassine paper or other similar paper. The inhibiting region 340 is made of silicon resin. Further, a filling layer, which is not shown, is provided between the release sheet body 330 and the inhibiting region 340 in order to prevent the release sheet body 330 from being impregnated with silicon resin of the inhibiting region 340. The filling layer is formed of polyethylene, clay coat, polyvinyl alcohol or other similar materials.

The pet absorbent sheet 100 before use has the release sheet 300 attached to the adhesion region 200. Therefore, in using the pet absorbent sheet 100, the release sheet 300 is removed from the adhesion region 200 by a user. Then the adhesion region 200 is attached to a placing object so that the pet absorbent sheet 100 is fixed to the placing object.

When removing the release sheet 300, the user can appropriately select the adhesive force between the pet absorbent sheet 100 and the placing object.

Specifically, when greater importance is placed on ease of removal of the pet absorbent sheet 100 from the placing object, only the first adhesion region 210 is exposed in the adhesion region 200. In this case, the release sheet 300 on the first adhesion region 210 is removed from the adhesion region 200, and the first adhesion region 210 is attached to the placing object.

When greater importance is placed on the fixing strength between the pet absorbent sheet 100 and the placing object, only the second adhesion region 220 is exposed in the adhesion region 200. In this case, the release sheet 300 on the second adhesion region 220 is removed from the adhesion region 200, and the second adhesion region 220 is attached to the placing object. In such a case where greater importance is placed on the fixing strength between the pet absorbent sheet 100 and the placing object, both the first and second adhesion regions 210, 220 may be exposed.

The release sheet 300 is disposed on the adhesion region 200 such that the first adhesion region 210 and the second adhesion region 220 are selectively exposed.

For example, a single release sheet 300 may be disposed over the first and second adhesion regions 210, 220. In this case, when the first adhesion region 210 is desired to be exposed, a region of the release sheet 300 facing the first adhesion region 210 is removed from the first adhesion region 210. Similarly, when the second adhesion region 220 is desired to be exposed, a region of the release sheet 300 facing the second adhesion region 220 is removed from the second adhesion region 220.

Alternatively, as described below, the release sheet 300 may be formed by a first release sheet 300A disposed on the first adhesion region 210 and a second release sheet 300B disposed on the second adhesion region 220.

In the pet absorbent sheet 100 according to this invention, as described above, the pet absorbent sheet 100 can be fixed to the placing object with a desired adhesive force. Therefore, the pet absorbent sheet 100 can be provided with improved usability.

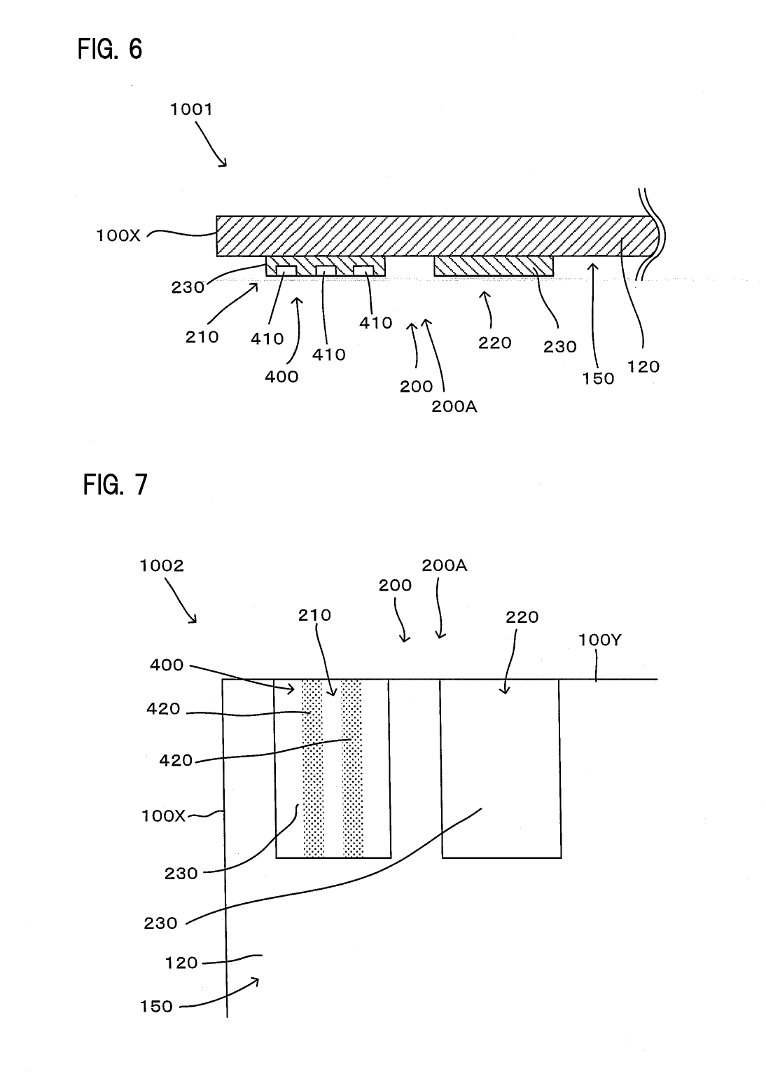

Now first to tenth embodiment patterns according to this invention are explained with reference to FIGS. 6 to 19. In the explanation, component elements identical or corresponding to those in the above-described pet absorbent sheet 100 having the basic structure, or to those in other embodiment patterns are given like numerals and are not described.

### First Embodiment Pattern

Referring to FIG. 6, a pet absorbent sheet 1001 according to the first embodiment pattern is now explained. FIG. 6 is a sectional view showing the adhesion region 200 in the pet absorbent sheet 1001 and corresponding to a sectional view taken along line VI-VI in FIG. 3.

The adhesives 230 having the same composition are applied to the first and second adhesion regions 210, 220 of the pet absorbent sheet 1001. The area of the first adhesion region 210 facing a placing object is the same as that of the second adhesion region 220.

An adhesive force reducing region 400 for reducing adhesive force is formed in the first adhesion region 210. The adhesive force reducing region 400 is a feature that corresponds to the “adhesive force reducing region” according to this invention.

The adhesive force reducing region 400 includes recesses 410 formed in part of the first adhesion region 210. The recesses 410 are formed by embossing. For this purpose, a known embossing method can be appropriately selected. The recesses 410 can be arranged in appropriately selected manner and positions, based on the intended or desired structure of the first adhesion region 210.

When the first adhesion region 210 is attached to a placing object, the adhesive 230 of the recess 410 does not adhere to the placing object. By provision of this adhesive force reducing region 400, the adhesive force in the first adhesion region 210 is rendered weaker than that in the second adhesion region 220. Thus, the first adhesion region 210 is formed in a different manner from the second adhesion region 220.

Therefore, the pet absorbent sheet 1001 according to the first embodiment pattern can achieve the effect of the above-described pet absorbent sheet 100 having the basic structure.

### Second Embodiment Pattern

Referring to FIG. 7, a pet absorbent sheet 1002 according to the second embodiment pattern is explained. FIG. 7 is an enlarged view showing the adjacent adhesion region 200A in the pet absorbent sheet 1002.

The pet absorbent sheet 1002 according to the second embodiment pattern has the adhesive force reducing region 400 different in structure from that of the pet absorbent sheet 1001 according to the first embodiment pattern.

In the pet absorbent sheet 1002 of the second embodiment pattern, the adhesive force reducing region 400 is formed in part of the first adhesion region 210 by applying powder 420 thereto. The powder 420 is arranged along the longitudinal direction Y in FIG. 7. The powder 420 can be arranged in appropriately selected manner and positions, based on the intended or desired structure of the first adhesion region 210. The powder may be formed of any materials in any structure, but gypsum, kaolin or other similar mineral-based materials, starch and pulp are suitably used as the powder.

When the first adhesion region 210 is attached to a placing object, the adhesive 230 having the powder 420 applied thereon does not adhere to the placing object. By provision of this adhesive force reducing region 400, the adhesive force in the first adhesion region 210 is rendered weaker than that in the second adhesion region 220. Thus, the first adhesion region 210 is formed in a different manner from the second adhesion region 220.

Therefore, the pet absorbent sheet 1002 according to the second embodiment pattern can achieve the effect of the above-described pet absorbent sheet 100 having the basic structure.

### Third Embodiment Pattern

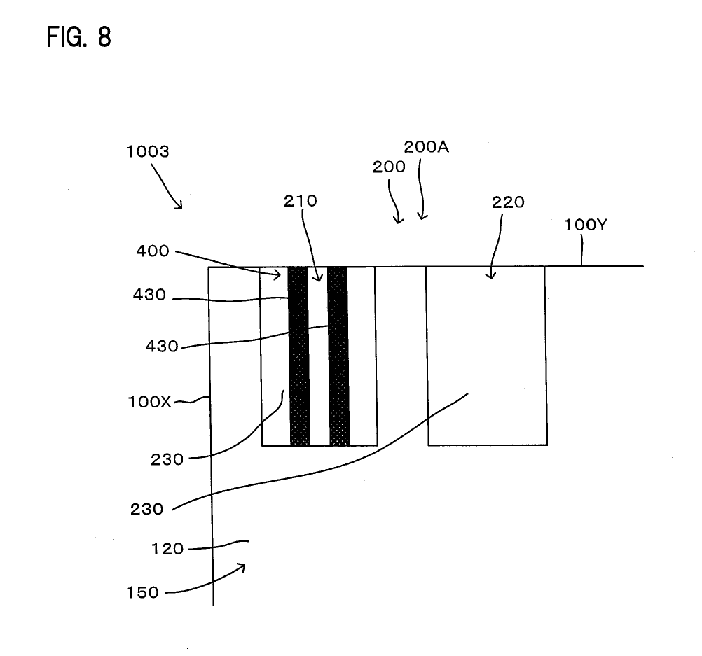

Referring to FIG. 8, a pet absorbent sheet 1003 according to the third embodiment pattern is explained. FIG. 8 is an enlarged view showing the adjacent adhesion region 200A in the pet absorbent sheet 1003.

The pet absorbent sheet 1003 according to the third embodiment pattern has the adhesive force reducing region 400 different in structure from that of the pet absorbent sheet 1001 according to the first embodiment pattern.

In the pet absorbent sheet 1003 of the third embodiment pattern, the adhesive force reducing region 400 is formed in part of the first adhesion region 210 by not providing the adhesive 230 therein. The part of the first adhesion region 210 which is not provided with the adhesive 230 is referred to as an adhesive-free region 430. The adhesive-free region 430 is arranged along the longitudinal direction Y in FIG. 8. The adhesive-free region 430 can be arranged in appropriately selected manner and positions, based on the intended or desired structure of the first adhesion region 210.

When the first adhesion region 210 is attached to a placing object, the adhesive-free region 430 does not adhere to the placing object. By provision of this adhesive force reducing region 400, the adhesive force in the first adhesion region 210 is rendered weaker than that in the second adhesion region 220. Thus, the first adhesion region 210 is formed in a different manner from the second adhesion region 220.

Therefore, the pet absorbent sheet 1003 according to the third embodiment pattern can achieve the effect of the above-described pet absorbent sheet 100 having the basic structure.

### Fourth Embodiment Pattern

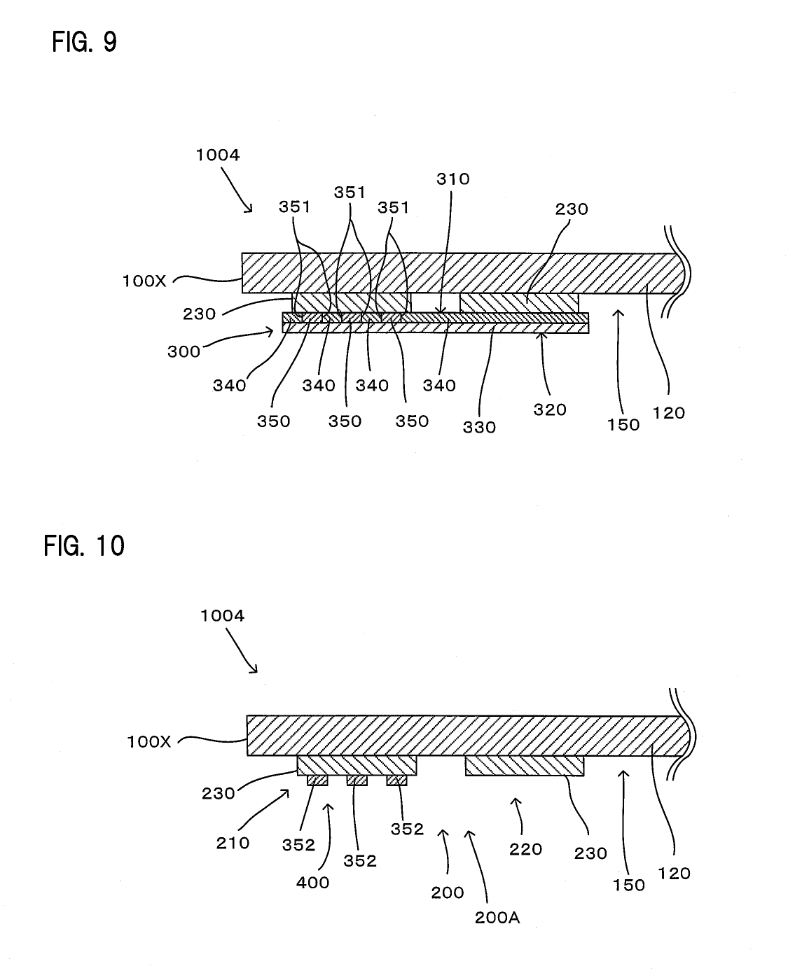

Referring to FIGS. 9 and 10, a pet absorbent sheet 1004 according to the fourth embodiment pattern is explained. FIGS. 9 and 10 are sectional views showing the adhesion region 200 in the pet absorbent sheet 1004 and corresponding to the sectional view taken along line VI-VI in FIG. 3.

The pet absorbent sheet 1004 according to the fourth embodiment pattern has the adhesive force reducing region 400 different in structure from that of the pet absorbent sheet 1001 according to the first embodiment pattern.

In the release sheet 300 which is used on the pet absorbent sheet 1004 of the fourth embodiment pattern, a promoting region 350 for promoting adhesion to the adhesion region 200 is formed in part of a first release sheet surface 310. The promoting region 350 is a feature that corresponds to the “promoting region” according to this invention. The promoting region 350 is provided in a predetermined position of the first release sheet surface 310 which faces the first adhesion region 210. The promoting region 350 can be arranged in appropriately selected manner and positions, based on the intended or desired structure of the first adhesion region 210.

The promoting region 350 can be formed by providing an adhesive in a predetermined position of the first release sheet surface 310 which faces the first adhesion region 210. The adhesive force of the adhesive in the promoting region 350 is weaker than that of the adhesive 230 in the second adhesion region 220.

The release sheet 300 has a first cut 351 formed by cutting along the periphery of the promoting region 350.

When the release sheet 300 having such a structure is removed from the first adhesion region 210, the promoting region 350 fixed to the adhesive 230 of the first adhesion region 210 and having the first cut 351 along its periphery is separated from the release sheet 300. Thus, the promoting region 350 is left attached to the first adhesion region 210 and forms a remaining promoting region 352. The remaining promoting region 352 forms the adhesive force reducing region 400.

The adhesive force of the remaining promoting region 352 is weaker than the adhesive force of the adhesive 230 of the adhesion region 200. By provision of the adhesive force reducing region 400, the adhesive force in the first adhesion region 210 is rendered weaker than that in the second adhesion region 220. Thus, the first adhesion region 210 is formed in a different manner from the second adhesion region 220.

Therefore, the pet absorbent sheet 1004 according to the forth embodiment pattern can achieve the effect of the above-described pet absorbent sheet 100 having the basic structure.

### Fifth Embodiment Pattern

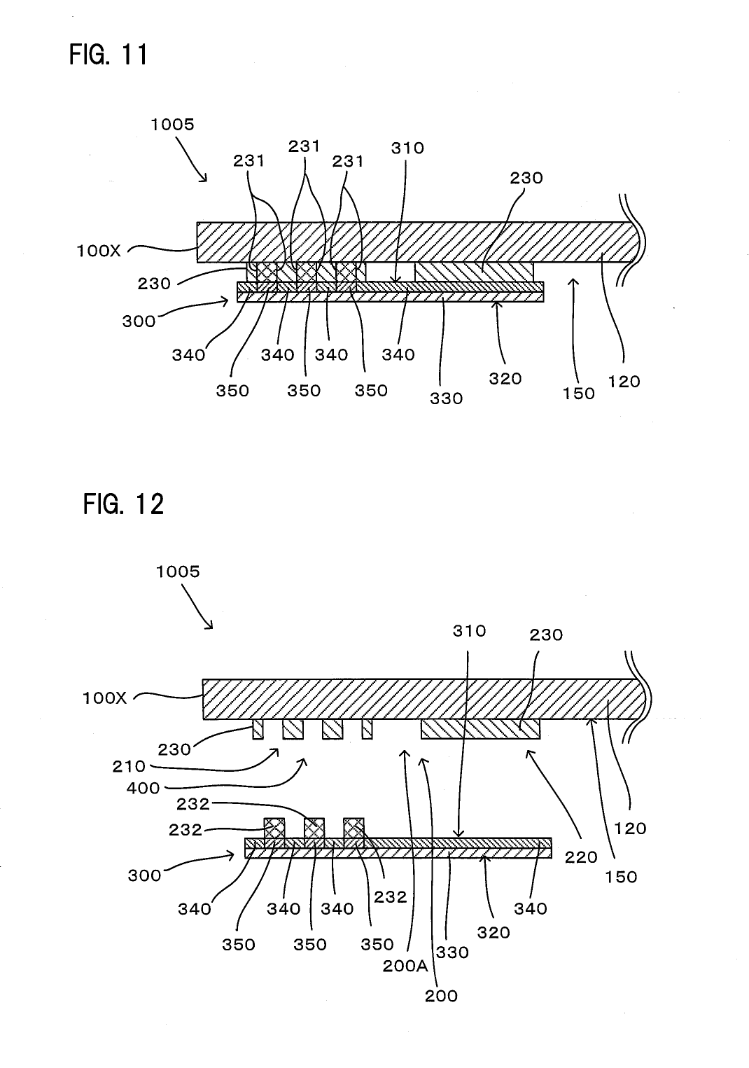

Referring to FIGS. 11 and 12, a pet absorbent sheet 1005 according to the fifth embodiment pattern is explained. FIGS. 11 and 12 are sectional views showing the adhesion region 200 in the pet absorbent sheet 1005 and corresponding to the sectional view taken along line VI-VI in FIG. 3.

The pet absorbent sheet 1005 according to the fifth embodiment pattern has the adhesive force reducing region 400 different in structure from that of the pet absorbent sheet 1001 according to the first embodiment pattern.

The same release sheet 300 as the pet absorbent sheet 1004 of the fourth embodiment pattern is used on the pet absorbent sheet 1005 of the fifth embodiment pattern. Therefore, the promoting region 350 for promoting adhesion to the adhesion region 200 is formed in part of the first release sheet surface 310 of the release sheet 300.

The first adhesion region 210 has a second cut 231 formed by cutting along the periphery of a part of the adhesive 230 in the first adhesion region 210. The region surrounded by the second cut 231 is provided and arranged to face the promoting region 350.

The region surrounded by the second cut 231 in the first adhesion region 210 is fixed to the promoting region 350 of the release sheet 300. Therefore, when the release sheet 300 having the above-described structure is removed from the first adhesion region 210, the region surrounded by the second cut 231 in the first adhesion region 210 is separated from the first adhesion region 210, while being left fixed to the promoting region 350. Thus, the adhesive 230 separated from the first adhesion region 210 forms a transition adhesive 232 on the release sheet 300. As a result, the region surrounded by the second cut 231 in the first adhesion region 210 is turned into a region free of the adhesive 230.

The region free of the adhesive 230 in the first adhesion region 210 forms the adhesive force reducing region 400.

By provision of this adhesive force reducing region 400, the adhesive force in the first adhesion region 210 is rendered weaker than that in the second adhesion region 220. Thus, the first adhesion region 210 is formed in a different manner from the second adhesion region 220. Therefore, the pet absorbent sheet 1005 according to the fifth embodiment pattern can achieve the effect of the above-described pet absorbent sheet 100 having the basic structure.

### Sixth Embodiment Pattern

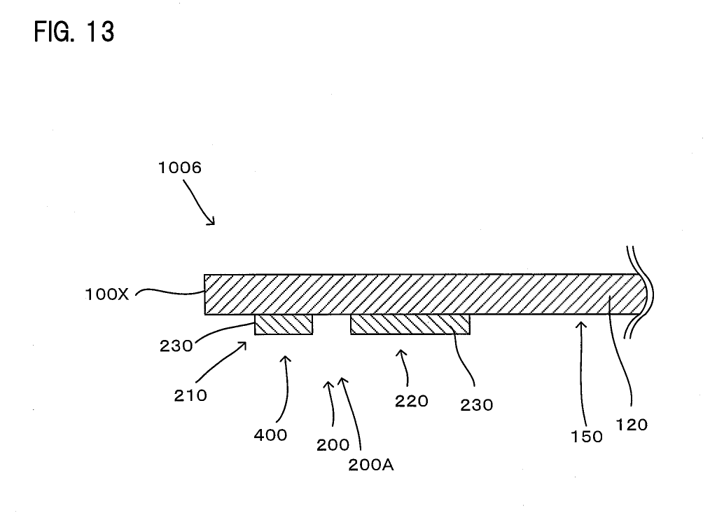

Referring to FIG. 13, a pet absorbent sheet 1006 according to the sixth embodiment pattern is explained. FIG. 13 is a sectional view showing the adhesion region 200 in the pet absorbent sheet 1006 and corresponding to the sectional view taken along line VI-VI in FIG. 3.

The pet absorbent sheet 1006 according to the sixth embodiment pattern has the adhesive force reducing region 400 different in structure from that of the pet absorbent sheet 1001 according to the first embodiment pattern.

In the adhesive force reducing region 400 of the pet absorbent sheet 1006 according to the sixth embodiment pattern, the area of the surface of the first adhesion region 210 which adheres to the placing object is smaller than that of the second adhesion region 220.

The adhesive force reducing region 400 is formed by provision of the difference in area between the surfaces of the first adhesion region 210 and the second adhesion region 220 which adhere to the placing object.

By provision of this adhesive force reducing region 400, the adhesive force in the first adhesion region 210 is rendered weaker than that in the second adhesion region 220. Thus, the first adhesion region 210 is formed in a different manner from the second adhesion region 220.

Therefore, the pet absorbent sheet 1006 according to the sixth embodiment pattern can achieve the effect of the above-described pet absorbent sheet 100 having the basic structure.

### Seventh Embodiment Pattern

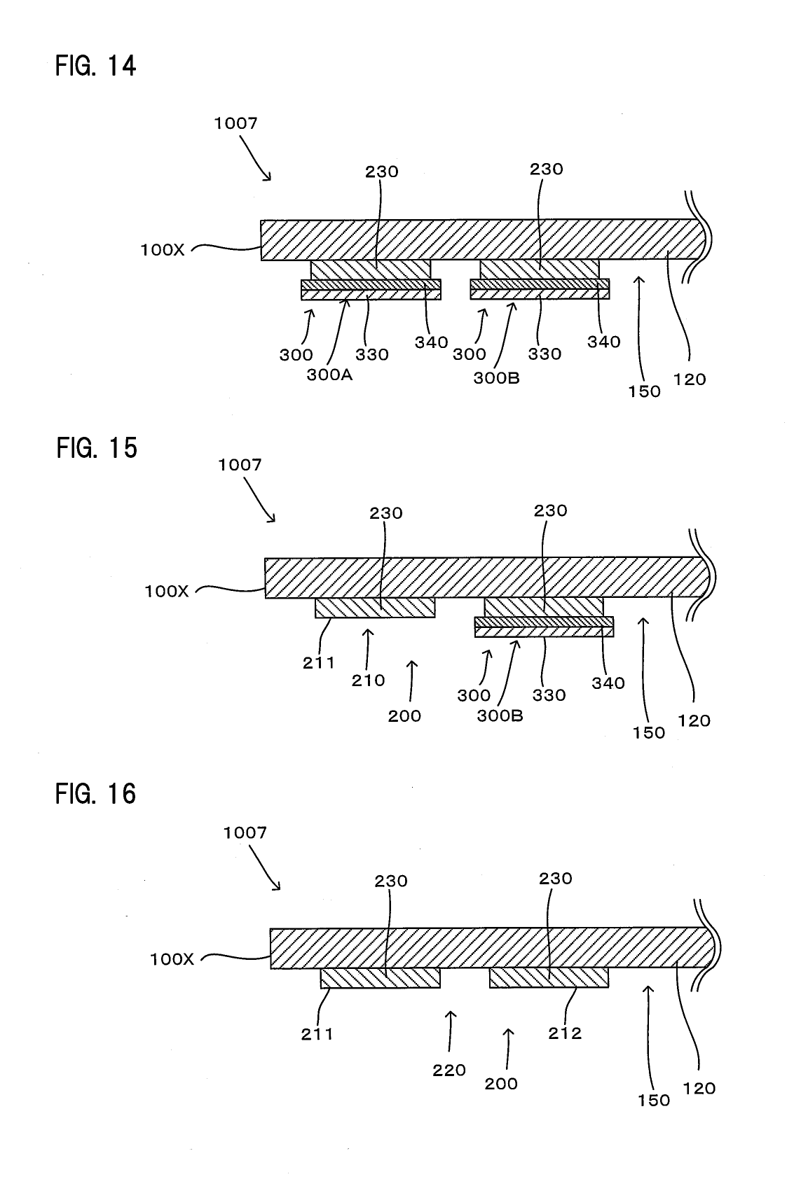

Referring to FIGS. 14 to 16, a pet absorbent sheet 1007 according to the seventh embodiment pattern is explained. FIGS. 14 to 16 are sectional views showing the adhesion region 200 in the pet absorbent sheet 1007 and corresponding to the sectional view taken along line VI-VI in FIG. 3.

The pet absorbent sheet 1007 according to the seventh embodiment pattern has a different means for reducing the adhesive force of the first adhesion region 210 from that of the pet absorbent sheet 1001 according to the first embodiment pattern.

As for the pet absorbent sheet 1007 of the seventh embodiment pattern, the release sheet 300 includes a first release sheet 300A and a second release sheet 300B. The first release sheet 300A and the second release sheet 300B are disposed on respective separate parts of the adhesion region 200.

The adhesive force reducing region 400 is formed by selectively removing the first release sheet 300A and the second release sheet 300B.

When a first release sheet surface 310 of the first release sheet 300A is separated from the adhesion region 200, the adhesion region 200 from which the first release sheet 300A is removed forms a first exposed region 211. The first exposed region 211 is a part of the adhesion region 200. The first exposed region 211 forms the first adhesion region 210.

Subsequently, a first release sheet surface 310 of the second release sheet 300B is separated from the adhesion region 200. Then the adhesion region 200 from which the second release sheet 300B is removed forms a second exposed region 221. The second exposed region 221 is a part of the adhesion region 200. By formation of the second exposed region 221 as well as the previously-formed first exposed region 211, the adhesion region 200 is entirely exposed. The first exposed region 211 and the second exposed region 221 form the second adhesion region 220.

In the pet absorbent sheet 1007 of the seventh embodiment pattern, the adhesive force in the first adhesion region 210 is also rendered weaker than that in the second adhesion region 220. Thus, the first adhesion region 210 is formed in a different manner from the second adhesion region 220.

Therefore, the pet absorbent sheet 1007 according to the seventh embodiment pattern can achieve the effect of the above-described pet absorbent sheet 100 having the basic structure.

In such cases in which the first and second adhesion regions 210, 220 are defined by the exposed area of the adhesion region 200 like the pet absorbent sheet 1007 of the seventh embodiment pattern, the other structures may also be selected to form the first and second adhesion regions 210, 220.

For example, a single release sheet 300 may be disposed over a plurality of separate parts of the adhesion region 200. In this case, when the first release sheet surface 310 of the release sheet 300 is separated from a part of the adhesion region 200, the first exposed region 211 is exposed and forms the first adhesion region 210. At this time, the release sheet 300 is not removed from the pet absorbent sheet, as being left fixed to the other part of the adhesion region 200.

When the first release sheet surface 310 is separated from the other part of the adhesion region 200, the second exposed region 221 is exposed and forms the second adhesion region 220.

Thus, even in a structure having the single release sheet 300, the first and second adhesion regions 210, 220 can be formed as in the above-described pet absorbent sheet 1007 of the seventh embodiment pattern.

Further, even in a structure in which the first and second release sheets 300A, 300B are provided on a single adhesion region 200, the first and second adhesion regions 210, 220 can be formed as in the above-described pet absorbent sheet 1007 of the seventh embodiment pattern.

Further, even in a structure in which a single release sheet 300 is provided on a single adhesion region 200, the area of separation of the first release sheet surface 310 of the single release sheet 300 from the adhesion region 200 can be adjusted. Therefore, the first and second adhesion regions 210, 220 can also be formed as in the above-described pet absorbent sheet 1007 of the seventh embodiment pattern.

### Eighth Embodiment Pattern

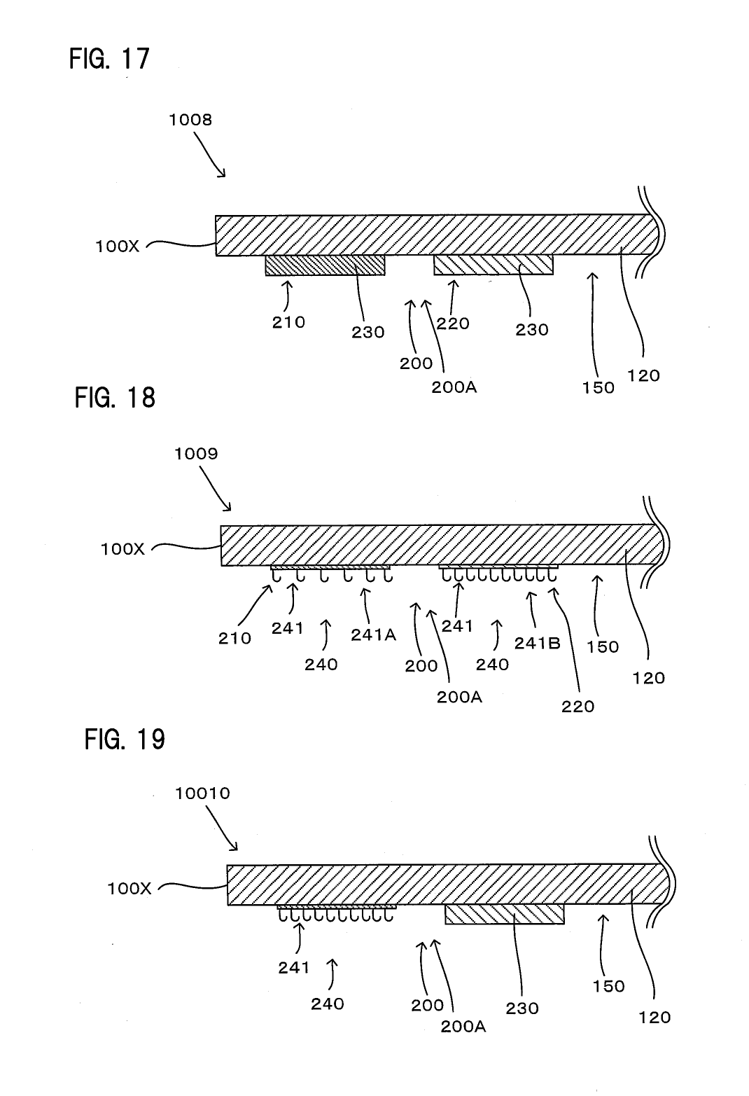

Referring to FIG. 17, a pet absorbent sheet 1008 according to the eighth embodiment pattern is explained. FIG. 17 is a sectional view showing the adhesion region 200 in the pet absorbent sheet 1008 and corresponding to the sectional view taken along line VI-VI in FIG. 3.

The pet absorbent sheet 1008 according to the eighth embodiment pattern has a different means for reducing the adhesive force of the first adhesion region 210 from that of the pet absorbent sheet 1001 according to the first embodiment pattern.

In the pet absorbent sheet 1008 of the eighth embodiment pattern, the adhesive 230 applied to the first adhesion region 210 has different composition from the adhesive 230 applied to the second adhesion region 220. The adhesive force of the adhesive 230 in the first adhesion region 210 is weaker than that in the second adhesion region 220.

The adhesive 230 for the first adhesion region 210 preferably has a tack strength under 5N, and the adhesive 230 for the second adhesion region 220 preferably has a tack strength of 5N or more.

The tack strength is obtained by the following measuring method.

### 1. Testing Machine

PICMA tack tester IMC-1567 (IMOTO Machinery Co., Ltd.)

### 2. Test Procedures

(1) An adhesion region 200 of 1 cm² is formed by applying an adhesive 230 to a flat and smooth stainless plate.
(2) The stainless plate is fixed with the adhesion region 200 facing a roll stand of the testing machine.
(3) The adhesion region 200 is attached to the roll stand of the testing machine.
(4) The roll stand is lifted at the speed of 30 mm/sec.
(5) A value measured upon separation of the adhesion region 200 from the roll stand is determined as the tack strength.

In the pet absorbent sheet 1008 of the eighth embodiment pattern, the adhesive force in the first adhesion region 210 is also rendered weaker than that in the second adhesion region 220. Thus, the first adhesion region 210 is formed in a different manner from the second adhesion region 220.

Therefore, the pet absorbent sheet 1008 according to the eighth embodiment pattern can achieve the effect of the above-described pet absorbent sheet 100 having the basic structure.

### Ninth Embodiment Pattern

Referring to FIG. 18, a pet absorbent sheet 1009 according to the ninth embodiment pattern is explained. FIG. 18 is a sectional view showing the adhesion region 200 in the pet absorbent sheet 1009 and corresponding to the sectional view taken along line VI-VI in FIG. 3.

In the pet absorbent sheet 1009 of the ninth embodiment pattern, an engagement region 240 having a plurality of hooks 241 forms the adhesion region 200. The adhesion region 200 formed by the engagement region 240 is particularly suitable when the placing object is fiber flooring.

The engagement region 240 includes a region having first hooks 241A and a region having second hooks 241B. The first hooks 241A have the same structure as the second hooks 241B. The number of the first hooks 241A is smaller than that of the second hooks 241B.

Therefore, the first hooks 241A form the first adhesion region 210, and the second hooks 241B form the second adhesion region 220.

In the pet absorbent sheet 1009 of the ninth embodiment pattern, the adhesive force in the first adhesion region 210 is also rendered weaker than that in the second adhesion region 220. Thus, the first adhesion region 210 is formed in a different manner from the second adhesion region 220.

Therefore, the pet absorbent sheet 1009 according to the ninth embodiment pattern can achieve the effect of the above-described pet absorbent sheet 100 having the basic structure.

### Tenth Embodiment Pattern

Referring to FIG. 19, a pet absorbent sheet 10010 according to the tenth embodiment pattern is explained. FIG. 19 is a sectional view showing the adhesion region 200 in the pet absorbent sheet 10010 and corresponding to the sectional view taken along line VI-VI in FIG. 3.

In the pet absorbent sheet 10010 of the tenth embodiment pattern, the adhesion region 200 includes an engagement region 240 having a plurality of hooks 241 and an adhesive region having the adhesive 230.

In the adhesion region 200 having the above-described structure, as described above, the first adhesion region 210 and the second adhesion region 220 are appropriately changed depending on the structure of the placing object or flooring. Specifically, when the flooring has a flat and smooth surface like vinyl flooring, the engagement region 240 forms the first adhesion region 210 and the adhesive region forms the second adhesion region 220. On the other hand, when the flooring has a fiber surface like a carpet, the adhesive region forms the first adhesion region 210 and the engagement region 240 forms the second adhesion region 220.

In the pet absorbent sheet 10010 of the tenth embodiment pattern, the adhesive force in the first adhesion region 210 is also rendered weaker than that in the second adhesion region 220. Thus, the first adhesion region 210 is formed in a different manner from the second adhesion region 220.

Therefore, the pet absorbent sheet 10010 according to the tenth embodiment pattern can achieve the effect of the above-described pet absorbent sheet 100 having the basic structure.

### Eleventh Embodiment Pattern

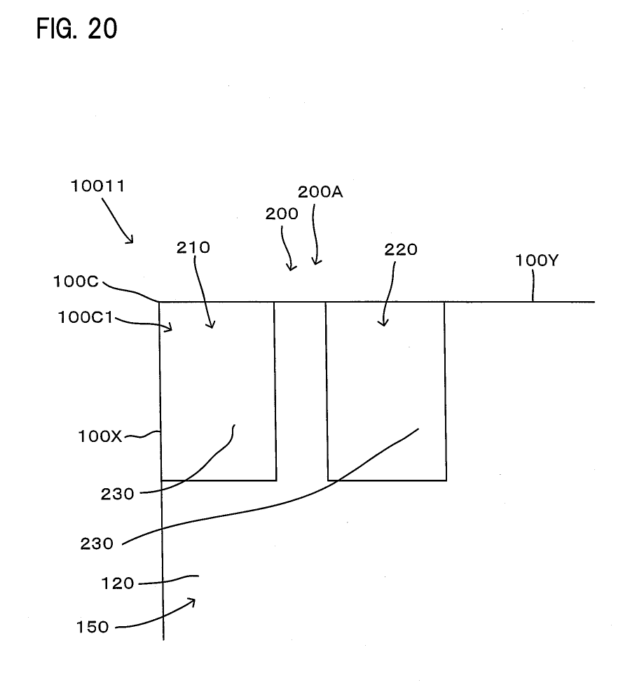

Referring to FIG. 20, a pet absorbent sheet 10011 according to the eleventh embodiment pattern is explained. FIG. 20 is an enlarged view showing an adjacent adhesion region 200A in the pet absorbent sheet 10011.

The above-described pet absorbent sheet 100 having the basic structure is described as being provided such that an end of the adhesion region 200 in the longitudinal direction Y coincides with the longitudinal end 100Y of the pet absorbent sheet 100, but arrangement of the adhesion region 200 on the pet absorbent sheet is not limited to this.

For example, like the pet absorbent sheet 10011 shown in FIG. 20, an end of the adhesion region 200 in the longitudinal direction Y and an end of the adhesion region 200 in the lateral direction X may coincide with the longitudinal end 100Y and the lateral end 100X of the pet absorbent sheet 10011, respectively. In this case, the adhesion region 200 is formed on the corner 100C of the pet absorbent sheet 10011.

In such a structure, compared with the pet absorbent sheet 100 having the basic structure, an area not having the adhesion region 200 can be reduced in a region including the ends 100Y, 100X of the pet absorbent sheet 10011. This makes more difficult for a pet to try to remove the pet absorbent sheet 10011.

Further, it may also be configured such that only the end of the adhesion region 200 in the lateral direction X and the lateral end 100X of the pet absorbent sheet coincide with each other.

### Twelfth Embodiment Pattern

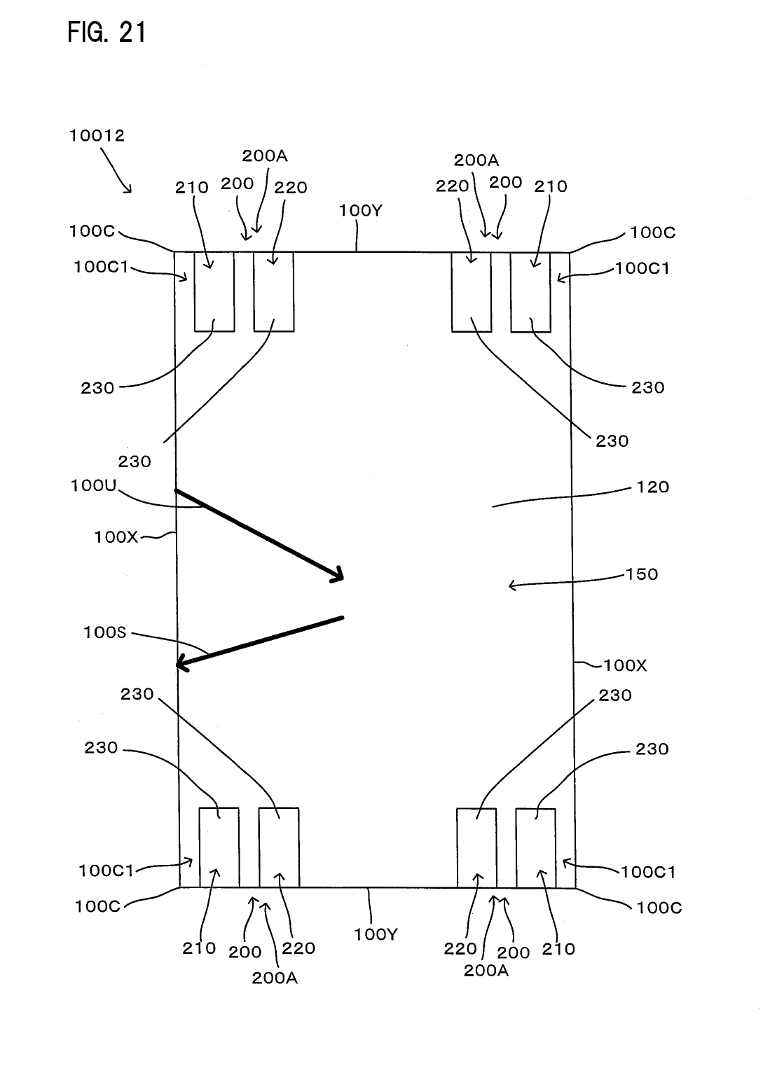

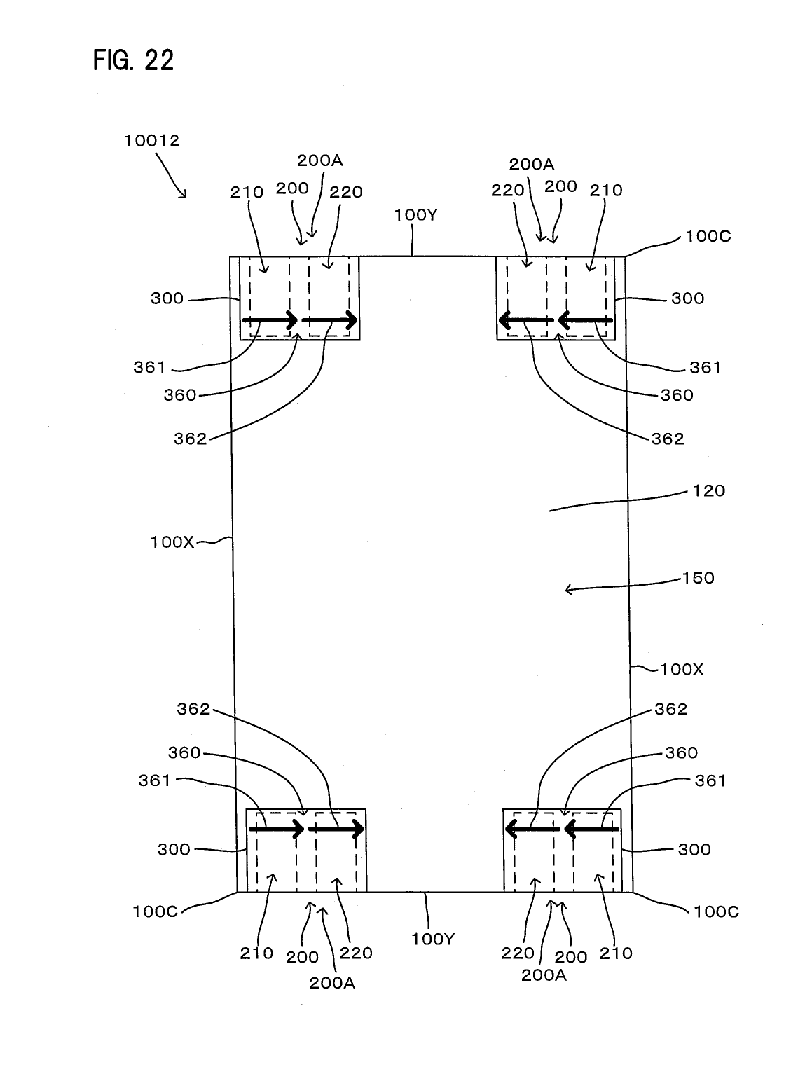

Referring to FIGS. 21 and 22, a pet absorbent sheet 10012 according to the twelfth embodiment pattern is explained. The twelfth embodiment pattern is related to arrangement of the first and second adhesion regions 210, 220 in the adjacent adhesion region 200A.

In the pet absorbent sheet 10012, an inward direction 100U from an end region (not shown) toward a central region (not shown) and an outward direction 100S from the central region toward the end region are defined. The end region refers to a region including the longitudinal end 100Y or the lateral end 100X in the pet absorbent sheet. The central region refers to a region including a center in the longitudinal direction Y and the lateral direction X and not including the end region in the pet absorbent sheet.

The pet absorbent sheet 10012 has a plurality of adjacent adhesion regions 200A. The pet absorbent sheet 10012 shown in FIGS. 21 and 22 has four adjacent adhesion regions 200A, but it is necessary to provide just a plurality of adjacent adhesion regions 200A. The number of the adjacent adhesion regions 200A can be arbitrarily chosen according to the pet absorbent sheet to be realized.

In the pet absorbent sheet 10012 according to the twelfth embodiment pattern, the first adhesion region 210 is arranged in an outward region in the outward direction 100S in a plurality of the adjacent adhesion regions 200A. In the pet absorbent sheet 10012 shown in the drawings, the first adhesion region 210 is arranged in the outward region in the outward direction 100S in each of the four adjacent adhesion regions 200A.

In the pet absorbent sheet 10012 according to the twelfth embodiment pattern, the adhesives 230 are applied to both of the first and second adhesion regions 210, 220. The adhesive 230 of the second adhesion region 220 has a stronger adhesive force than the adhesive 230 of the first adhesion region 210. Therefore, the pet absorbent sheet 10012 according to the twelfth embodiment pattern can achieve the effect of the above-described pet absorbent sheet 100 having the basic structure.

In the pet absorbent sheet 10012, the first adhesion region 210 having a weaker adhesive force is arranged in the outward region in the outward direction 100S. In this case, it is advantageous and preferable that the end region of the pet absorbent sheet 10012 is attached to a placing object in order to prevent the pet absorbent sheet 10012 from being turned up. For this purpose, it is preferable to expose the first adhesion region 210 prior to the second adhesion region 220.

FIG. 22 shows the pet absorbent sheet 10012 with the release sheet 300 attached thereto. The release sheet 300 has a display part 360. The display part 360 includes a first display part 361 for indicating a direction to expose the first adhesion region 210 first and a second display part 362 for indicating a direction to expose the second adhesion region 220 next. In FIG. 22, the first and second display parts 361, 362 indicate the direction in which the release sheet 300 is removed. The display part 360 is not limited to this. For example, concrete words and phrases may be used for the display part 360 to indicate that the first adhesion region 210 is to be exposed first and the second adhesion region 210 is to be exposed next.

By provision of the display part 360, the user can reliably expose both of the first and second adhesion regions 210, 220.

Therefore, in the pet absorbent sheet 10012, only the first adhesion region 210 can be used for a placing object which requires only a weak adhesive force to attach, while both the first and second adhesion regions 210, 220 can be used for a placing object which requires a strong adhesive force to attach.

### Thirteenth Embodiment Pattern

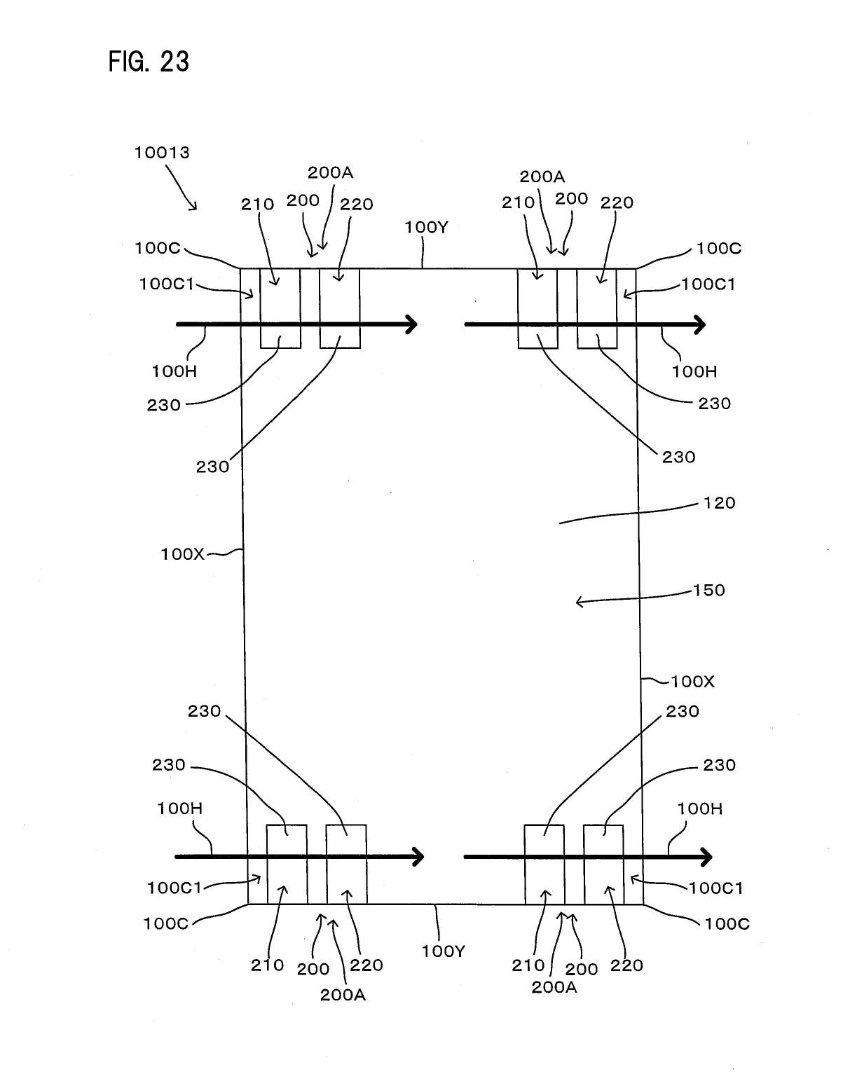

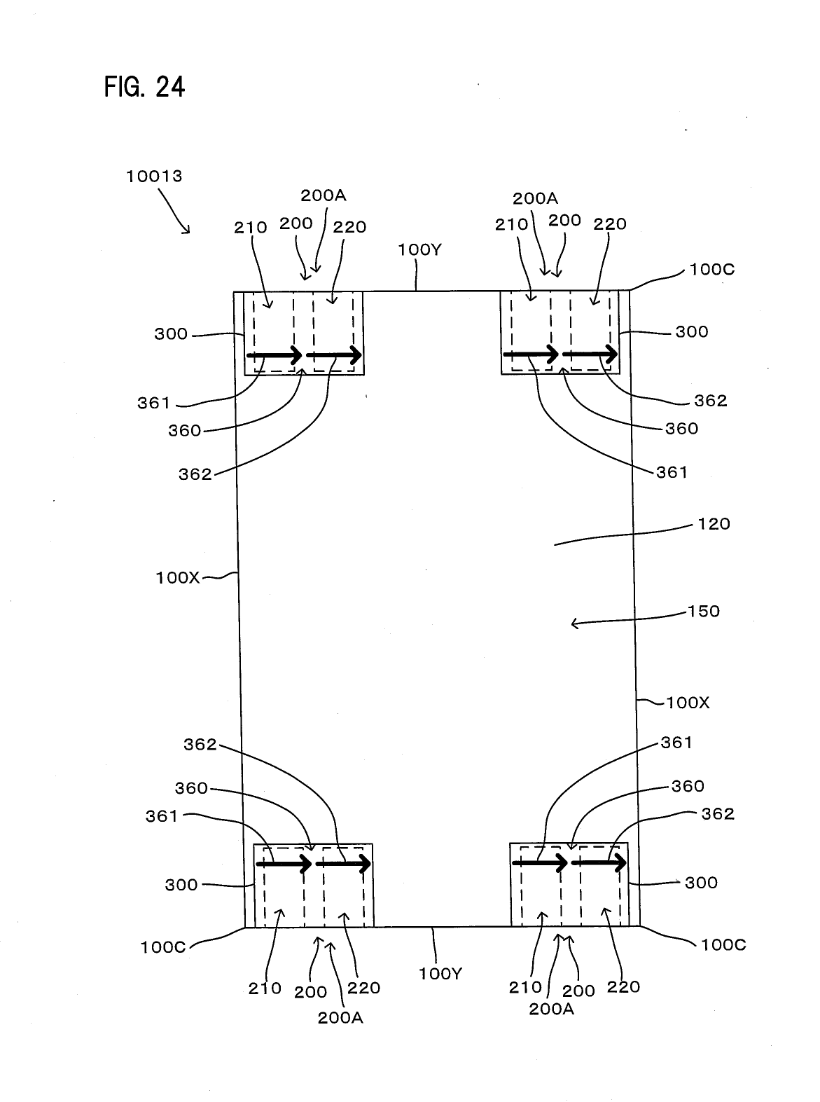

Referring to FIGS. 23 and 24, a pet absorbent sheet 10013 according to the thirteenth embodiment pattern is explained. Like the twelfth embodiment pattern, the thirteenth embodiment pattern is related to arrangement of the first and second adhesion regions 210, 220 in the adjacent adhesion region 200A.

In the pet absorbent sheet 10013 of the thirteenth embodiment pattern, the first adhesion region 210 and the second adhesion region 220 are arranged in the same order in an arrangement direction 100H in a plurality of the adjacent adhesion regions 200A. In the pet absorbent sheet 10013 shown in the drawings, the first adhesion region 210 and the second adhesion region 220 are arranged in the same order in the arrangement direction 100H in each of the four adjacent adhesion regions 200A.

FIG. 24 shows the pet absorbent sheet 10013 with the release sheet 300 attached to the adhesion region 200. The release sheet 300 has a display part 360. The display part 360 includes a first display part 361 for indicating a direction to expose the first adhesion region 210 and a second display part 362 for indicating a direction to expose the second adhesion region 220.

In using the above-described pet absorbent sheet 10013, the user exposes the first adhesion region 210 and attaches it to a placing object in the following manner. The user removes the release sheet 300 from the first adhesion region 210 from left to right as viewed in FIG. 24. The direction of removing the release sheet 300 to expose the first adhesion region 210 is the same in the entire adhesion region 200.

Specifically, when removing the release sheet 300 from the first adhesion region 210, the user holds the end of the release sheet 300 and turns or moves the wrist. The operations of turning or moving the user's wrist in order to remove the release sheet 300 are performed in the same direction in the entire adhesion region 200 of the pet absorbent sheet 10013. Therefore, the pet absorbent sheet 10013 of the thirteenth embodiment pattern can be provided with improved user-friendliness.

The structures of the pet absorbent sheets according to the present invention are not limited to those as described above. The basic structure and the features of the first to thirteenth embodiment patterns can be applied in appropriate combinations.

### (Correspondences Between the Features of the Embodiment and the Features of the Invention)

The pet absorbent sheets 100, 1001, 1002, 1003, 1004, 1005, 1006, 1007, 1008, 1009, 10011, 10012, 10013 are features that correspond to the “pet absorbent sheet” according to this invention. The top sheet 110, the back sheet 120 and the absorbing core 130 are features that correspond to the “first sheet”, the “second sheet” and the “absorbing core”, respectively, according to this invention. The excretion surface 140 and the placing surface 150 are features that correspond to the “excretion surface” and the “placing surface”, respectively, according to this invention. The adhesion region 200, the first adhesion region 210 and the second adhesion region 220 are features that correspond to the “adhesion region”, the “first adhesion region” and the “second adhesion region”, respectively, according to this invention. The adhesive 230 and the hooks 241 are features that correspond to the “adhesive” and the “hooks”, respectively, according to this invention. The adhesive force reducing region 400 is a feature that corresponds to the “adhesive force reducing region” according to this invention. The release sheet 300, the first release sheet surface 310 and the second release sheet surface 320 are features that correspond to the “release sheet”, the “first release sheet surface”, and the “second release sheet surface”, respectively, according to this invention. The inhibiting region 340 and the promoting region 350 are features that correspond to the “inhibiting region” and the “promoting region”, respectively, according to this invention.

In view of the above-described nature of the present invention, the following various provisions can be made.

(1)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein:

the placing surface has an adhesion region which can adhere to a placing object, and the adhesion region has a first adhesion region and a second adhesion region formed in a different manner from the first adhesion region, and

adhesive force in the first adhesion region is rendered weaker than adhesive force in the second adhesion region.

(2)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein:

the placing surface has an adhesion region which can adhere to a placing object, and the adhesion region has a first adhesion region and a second adhesion region formed in a different manner from the first adhesion region,

adhesive force in the first adhesion region is rendered weaker than adhesive force in the second adhesion region, and

the adhesion region comprises an adhesive region having an adhesive applied thereto.

(3)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein:

the placing surface has an adhesion region which can adhere to a placing object, and the adhesion region has a first adhesion region and a second adhesion region formed in a different manner from the first adhesion region,

adhesive force in the first adhesion region is rendered weaker than adhesive force in the second adhesion region,

the adhesion region comprises an adhesive region having an adhesive applied thereto, and

the adhesives having the same composition are applied to the first and second adhesion regions, and an adhesive force reducing region for reducing adhesive force is formed in the first adhesion region.

(4)

The pet absorbent sheet as defined in (3), wherein the adhesive force reducing region is formed in part of the first adhesion region by embossing.

(5)

The pet absorbent sheet as defined in (3), wherein the adhesive force reducing region is formed in part of the first adhesion region by applying powder thereto.

(6)

The pet absorbent sheet as defined in (3), wherein the adhesive force reducing region is formed in part of the first adhesion region by not providing the adhesive therein.

(7)

The pet absorbent sheet as defined in (3), wherein the adhesive force reducing region is formed by providing such that the area of a surface of the first adhesion region which adheres to the placing object is smaller than that of the second adhesion region.

(8)

The pet absorbent sheet as defined in any one of (1) to (7), further comprising a release sheet disposed on at least part of the adhesion region, wherein the release sheet has a first release sheet surface on one side facing the adhesion region and a second release sheet surface on the other side,

wherein the first release sheet surface has an inhibiting region for inhibiting adhesion to the adhesion region, and a promoting region for promoting adhesion to the adhesion region.

(9)

The pet absorbent sheet as defined in (8), wherein the release sheet has a first cut formed by cutting along a periphery of the promoting region, and wherein, when the release sheet is removed from the adhesion region, the promoting region is separated from the release sheet by the first cut and left on the first adhesion region, thereby forming the adhesive force reducing region.

(10)

The pet absorbent sheet as defined in (8), wherein the first adhesion region has a second cut formed by cutting along a periphery of a part of the adhesive in the first adhesion region, and wherein, when the release sheet is removed from the adhesion region, said part of the adhesive is separated from the first adhesion region by the second cut and moved onto the promoting region, thereby forming the adhesive force reducing region.

(11)

The pet absorbent sheet as defined in any one of (1) to (7), further comprising a release sheet disposed on at least part of the adhesion region, wherein the release sheet has a first release sheet surface on one side facing the adhesion region and a second release sheet surface on the other side,

wherein the adhesives having the same composition are applied to the first and second adhesion regions,

the first adhesion region comprises a first exposed region exposed by separation of the first release sheet surface from a part of the adhesion region, and

the second adhesion region comprises a second exposed region which is larger than the first exposed region.

(12)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein:

the placing surface has an adhesion region which can adhere to a placing object, and the adhesion region has a first adhesion region and a second adhesion region formed in a different manner from the first adhesion region,

adhesive force in the first adhesion region is rendered weaker than adhesive force in the second adhesion region,

the adhesion region comprises an adhesive region having an adhesive applied thereto, and

adhesives having different composition are applied to the first and second adhesion regions, and adhesive force in the first adhesion region is rendered weaker than adhesive force in the second adhesion region.

(13)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein:

the placing surface has an adhesion region which can adhere to a placing object, and the adhesion region has a first adhesion region and a second adhesion region formed in a different manner from the first adhesion region,

adhesive force in the first adhesion region is rendered weaker than adhesive force in the second adhesion region, and

the adhesion region comprises an engagement region having a plurality of hooks.

(14)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein:

the placing surface has an adhesion region which can adhere to a placing object, and the adhesion region has a first adhesion region and a second adhesion region formed in a different manner from the first adhesion region, and

the adhesion region comprises an adhesive region having an adhesive applied thereto and an engagement region having a plurality of hooks.

(15)

The pet absorbent sheet as defined in any one of (1) to (14), wherein the first and second adhesion regions adjacent to each other form an adjacent adhesion region, and a plurality of such adjacent adhesion regions are arranged on the placing surface of the pet absorbent sheet.

(16)

The pet absorbent sheet as defined in (15), wherein the adjacent adhesion regions are provided in corner regions on the placing surface of the pet absorbent sheet.

(17)

The pet absorbent sheet as defined in any one of (1) to (16), wherein an end of the adhesion region coincides with an end of the pet absorbent sheet.

(18)

The pet absorbent sheet as defined in any one of (1) to (17), wherein an inward direction from an end region toward a central region of the pet absorbent sheet and an outward direction from the central region toward the end region are defined, and a pair of the first and second adhesion regions adjacent to each other forms an adjacent adhesion region.

(19)

The pet absorbent sheet as defined in (18), wherein a plurality of such adjacent adhesion regions are formed, and in a plurality of the adjacent adhesion regions, the first adhesion region is arranged in an outward region in the outward direction.

(20)

The pet absorbent sheet as defined in (18), wherein a plurality of such adjacent adhesion regions are formed and the first adhesion region and the second adhesion region are arranged in the same order in an arrangement direction in the adjacent adhesion regions.

(21)

The pet absorbent sheet as defined in any one of (19) to (20), wherein the release sheet has a display part for indicating that the first adhesion region is to be exposed first and the second adhesion region is to be exposed next.

### DESCRIPTION OF NUMERALS

100, 1001, 1002, 1003, 1004, 1005, 1006, 1007, 1008, 1009, 10011, 10012, 10013 pet absorbent sheet
110C corner
100C1 corner region
100H arrangement direction
100S outward direction
100U inward direction
100X lateral end
100Y longitudinal end
110 top sheet (first sheet)
120 back sheet (second sheet)
130 absorbing core
140 excretion surface
150 placing surface
200 adhesion region
200A adjacent adhesion region
210 first adhesion region
211 first exposed region
220 second adhesion region
221 second exposed region
230 adhesive
231 second cut
232 transition adhesive
240 engagement region
241 hook
241A first hook
241B second hook
300 release sheet
300A first release sheet
300B second release sheet
310 first release sheet surface
320 second release sheet surface
330 release sheet body
340 inhibiting region
350 promoting region
351 first cut
352 remaining promoting region
360 display part
361 first display part
362 second display part
400 adhesive force reducing region
410 recess
420 powder
430 adhesive-free region
X lateral direction
Y longitudinal direction

1. A pet absorbent sheet, comprising:
a liquid-permeable first sheet,
a liquid-impermeable second sheet,
an absorbing core disposed between the first sheet and the second sheet, an excretion surface on which a pet excretes, and
a placing surface opposite to the excretion surface, wherein:
the placing surface has an adhesion region which can adhere to a placing object, and the adhesion region has a first adhesion region and a second adhesion region formed in a different manner from the first adhesion region.

2. The pet absorbent sheet as defined in claim 1, wherein adhesive force in the first adhesion region is rendered weaker than adhesive force in the second adhesion region, whereby the first adhesion region is formed in a different manner from the second adhesion region.

3. The pet absorbent sheet as defined in claim 1, wherein the adhesion region comprises an adhesive region having an adhesive applied thereto.

4. The pet absorbent sheet as defined in claim 3, wherein adhesives having the same composition are applied to the first and second adhesion regions, and an adhesive force reducing region for reducing adhesive force is formed in the first adhesion region.

5. The pet absorbent sheet as defined in claim 4, wherein the adhesive force reducing region is formed in part of the first adhesion region by embossing.

6. The pet absorbent sheet as defined in claim 4, wherein the adhesive force reducing region is formed in part of the first adhesion region by applying powder thereto.

7. The pet absorbent sheet as defined in claim 4, wherein the adhesive force reducing region is formed in part of the first adhesion region by not providing the adhesive therein.

8. The pet absorbent sheet as defined in claim 1, further comprising a release sheet disposed on at least part of the adhesion region, wherein the release sheet has a first release sheet surface on one side facing the adhesion region and a second release sheet surface on the other side.
